(19) United States
(12) Patent Application Publication
(10) Pub. No.: US 2010/0193103 A1
(43) Pub. Date: Aug. 5, 2010

(54) AUTOMATED FIBER PLACEMENT USING NETWORKED AUTONOMOUS VEHICLES

(75) Inventor: Peter D. McCowin, Enumclaw, WA (US)

Correspondence Address: TUNG & ASSOCIATES, Suite 120, 838 W. Long Lake Road, Bloomfield Hills, MI, 48302, US

(73) Assignee: The Boeing Company

(21) Appl. No.: 12/363,749

(22) Filed: Jan. 31, 2009

(51) Int. Cl. B32B 37/00

(52) U.S. Cl. 156/60; 156/350

(57) ABSTRACT

A composite laminate is laid up by applying differently configured courses of composite tape over different sectors of a tool surface using a plurality of independently controlled tape application vehicles.

### CROSS REFERENCE TO RELATED APPLICATIONS

This application is related to co-pending U.S. patent application Ser. Nos. 11/116,222, filed Apr. 28, 2005 and published Nov. 23, 2006 as US Publication No. 20060260751 A1; 11/750,154 filed May 17, 2007 and published Nov. 20, 2008 as US Publication No. 20080282863 A1; 11/196,455 filed Aug. 4, 2005 and published Feb. 8, 2007 as US Publication No. 20070029030 A1; and 12/038,155 filed Feb. 27, 2008, all of which applications are incorporated by reference herein in their entirety.

### TECHNICAL FIELD

This disclosure generally relates to fabrication of large scale composite structures using automated fiber placement techniques, and deals more particularly with a system for automated fiber placement using networked autonomous fiber placement vehicles.

### BACKGROUND

Composite structures such as those used in the automotive, marine and aerospace industries may be fabricated using automated composite material application machines, commonly referred to as automated fiber placement (AFP) machines. AFP machines may be used in the aircraft industry, for example, to fabricate structural shapes and skin assemblies by wrapping relatively narrow strips of slit composite tape or “tows”, collimated into a wider band, on or around a manufacturing tool. The AFP machine aligns and places a plurality of tape strips, typically six or more, in substantially continuous, substantially edge-to-edge contact forming a single wide, conformal band which is placed on and compacted against the tool.

While current AFP machines are highly flexible and efficient, their productivity may be limited in higher production environments. For example, current AFP machines may employ a single head containing six to eight tape control modules that may lay down a bandwidth of six to eight tape courses. In order to increase productivity, additional tape control modules may be added to the head order to increase the bandwidth. Also, it may be possible to use multiple tape application heads, each mounted on a robotic device, such as a NC controlled gantry, however this approach also has limitations. The use of multiple robotic devices results in increased machine complexity and greater mass which may adversely affect machine reliability and/or limit velocity and/or acceleration profiles. Moreover, the use of fixed structural robotic devices such as foundation-based gantry systems may represent a significant capital investment and may limit functional flexibility as well as the ability to expand future production capacity.

Accordingly, there is a need for a system and method for rapid automated assembly of composite laminate parts and structures employing automated tape placement, that increases productivity while providing greater operational flexibility. There is also a need for a reduced cost system and method having reduced complexity and high reliability.

### SUMMARY

The disclosed embodiments provide improvements in laminate course placement and assembly of composite parts and structures through the use of networked, autonomous fiber placement vehicles. The fiber placement vehicles employ tape application heads that may be tailored in complexity to best match the tape application task for a particular area of the laminate structure. Tape application rate may be increased by adding additional vehicles. The use of multiple, autonomous tape application vehicles increase overall system reliability while reducing down time.

According to one disclosed embodiment, a system is provided for fabricating a composite structure. A plurality of independently operable vehicles perform differing tape application tasks and are arranged in a network. A control system is provided for controlling the independent operation of the vehicles.

According to another disclosed embodiment, a system is provided for fabricating a composite laminate structure. A plurality of tape application vehicles are independently moveable over a tool surface and respectively include differently configured tape application heads for independently applying differently configured courses of composite tape over the tool surface. Control means arte provided for controlling both the independent movement of the vehicles over the tool surface, and the operation of the tape application heads. In one embodiment, the tool surface is divided into a plurality of sectors and the vehicles are respectively associated with and operate within the sectors.

According to a disclosed method embodiment, courses of composite tape are applied over a tool surface. A plurality of autonomous vehicles are coupled in a network. Each of the vehicles is equipped with a composite tape application head for applying courses of composite tape over the tool surface. Operation of the vehicles is coordinated within the network and the vehicles are dispatched to apply courses of composite tape in different areas of the tool surface.

According to another disclosed method embodiment, laying up a composite laminate comprises applying differently configured courses of composite tape over different sectors of a tool surface using a plurality of independently controlled tape application vehicles.

The disclosed embodiments satisfy the need for a system and method for assembling laminate structures that employs multiple autonomous tape application vehicles operating within a network to simultaneously perform differing tape application tasks on different areas of the tool surface.

### BRIEF DESCRIPTION OF THE ILLUSTRATIONS

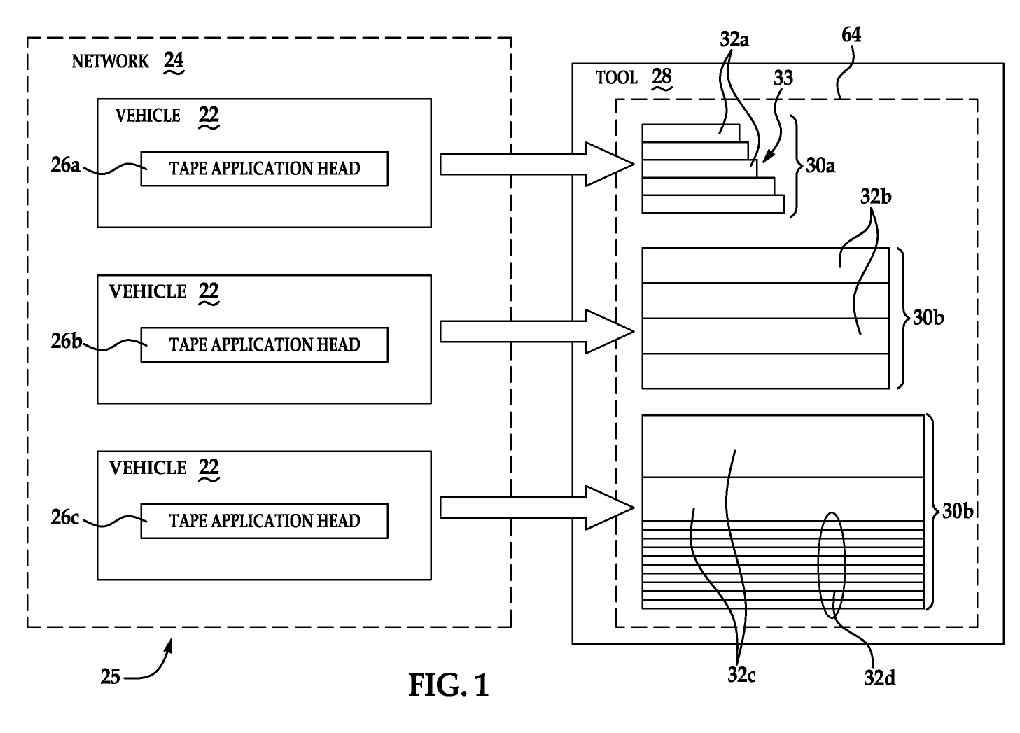

FIG. 1 is an illustration of a functional block diagram of a system for automated fiber placement using networked autonomous vehicles.

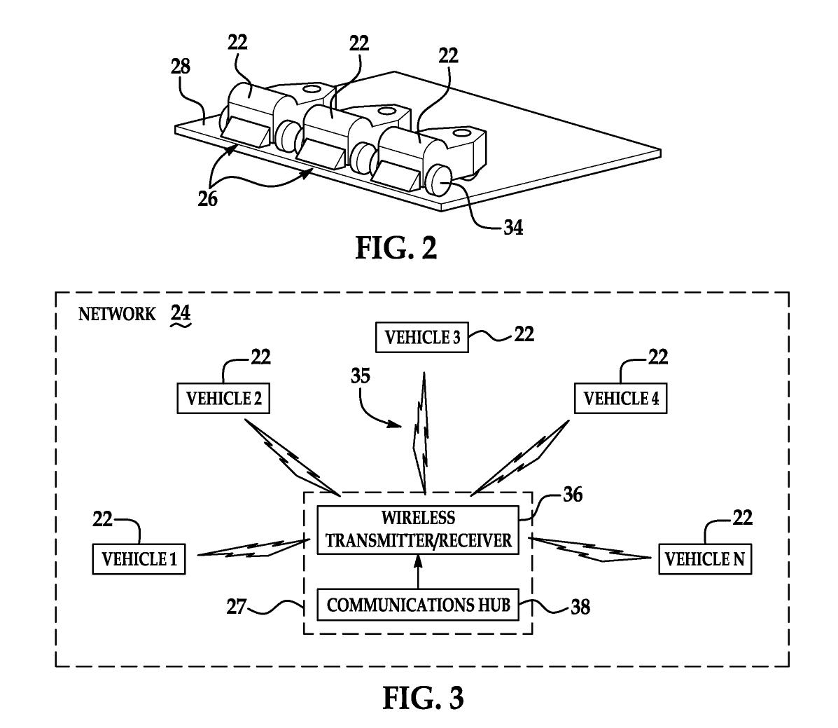

FIG. 2 is a perspective illustration of the autonomous vehicles.

FIG. 3 is an illustration of a block diagram of the components of the vehicle network.

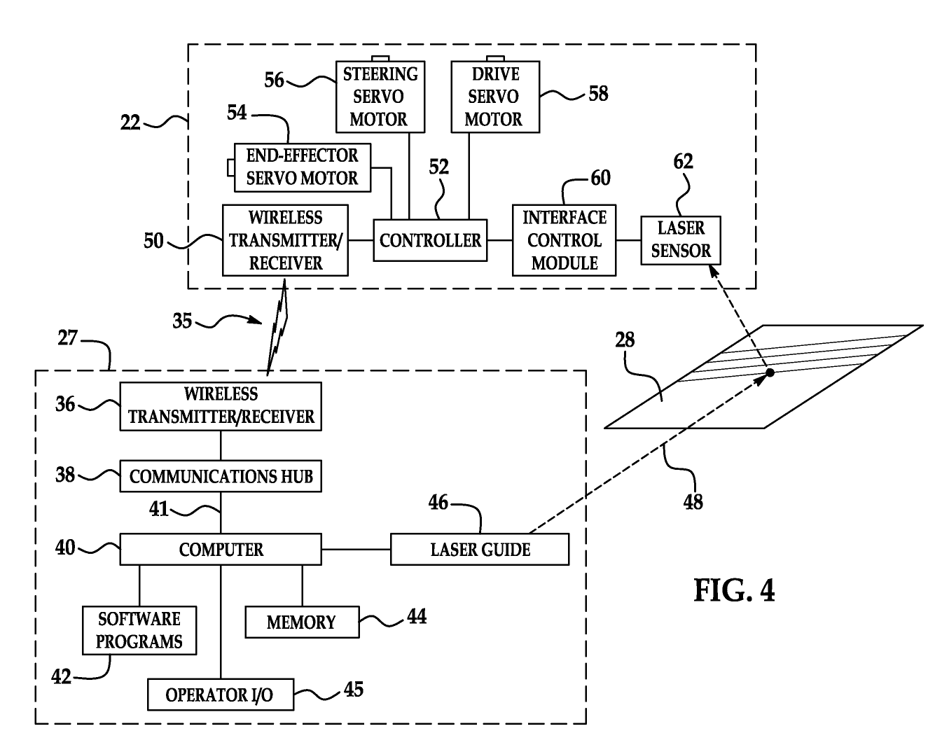

FIG. 4 is an illustration of a combined block and diagrammatic view of components of the network, and components of one of the autonomous vehicles.

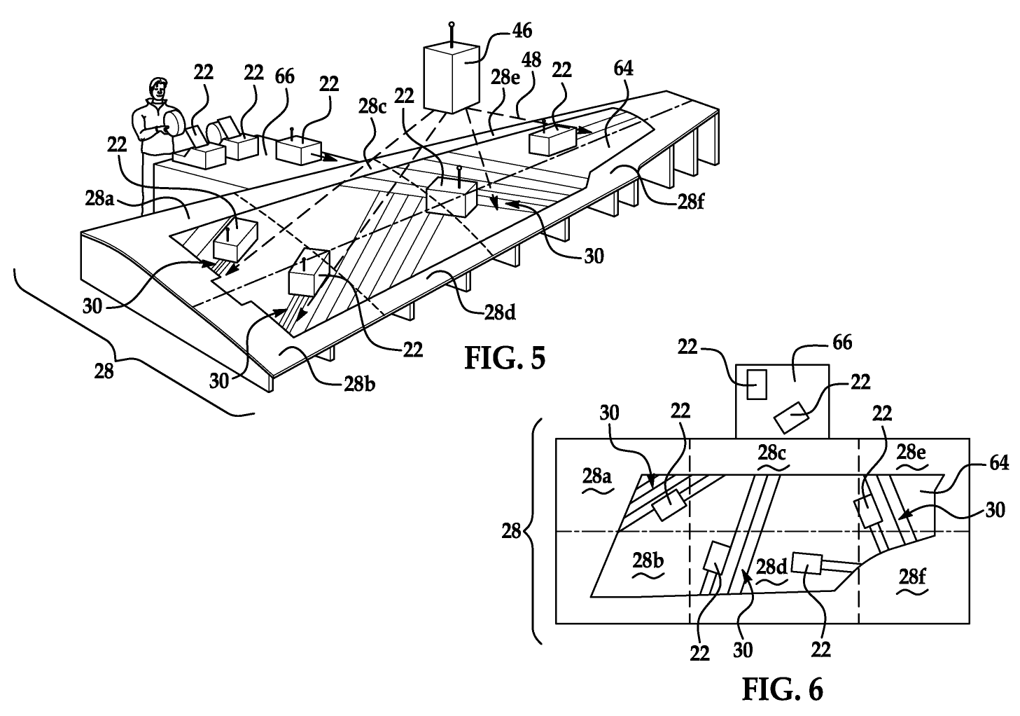

FIG. 5 is an illustration of a perspective view of a typical factory floor environment in which a network of autonomous vehicles is used to assemble a composite laminate.

FIG. 6 is a plan view illustration of the production environment shown in FIG. 5.

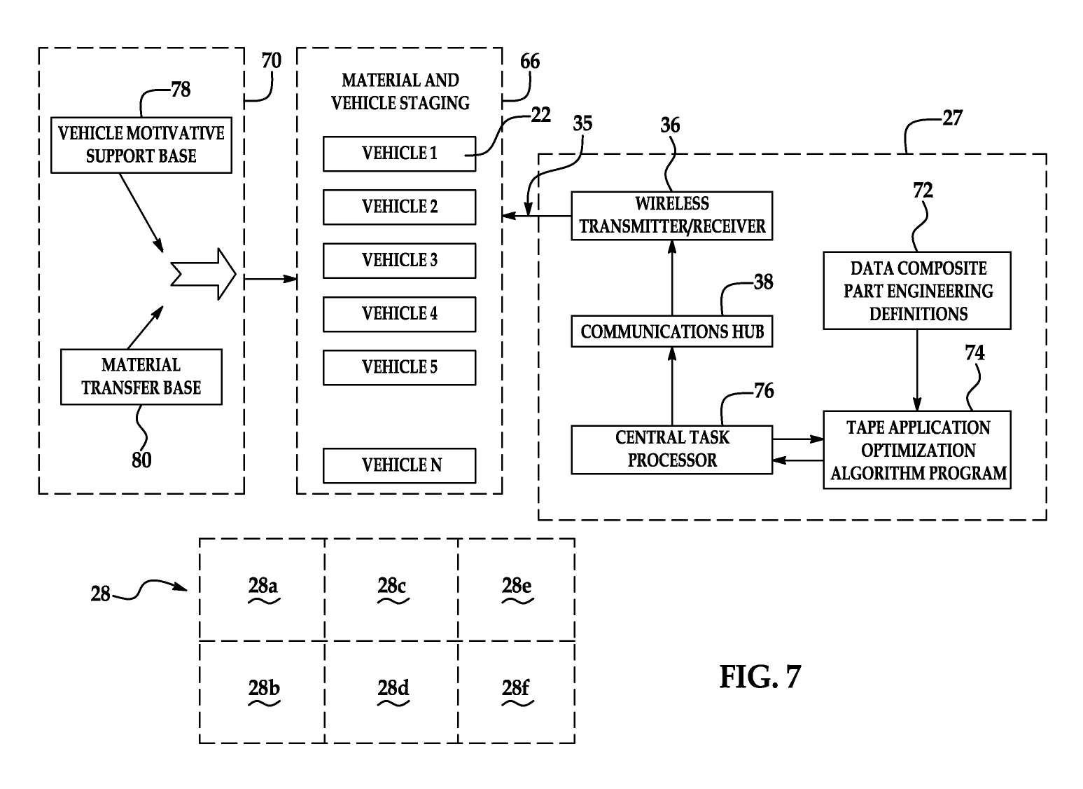

FIG. 7 is an illustration of a combined block and diagrammatic view showing components of the system in relation to sectors of a tool surface upon which the laminate structure is formed.

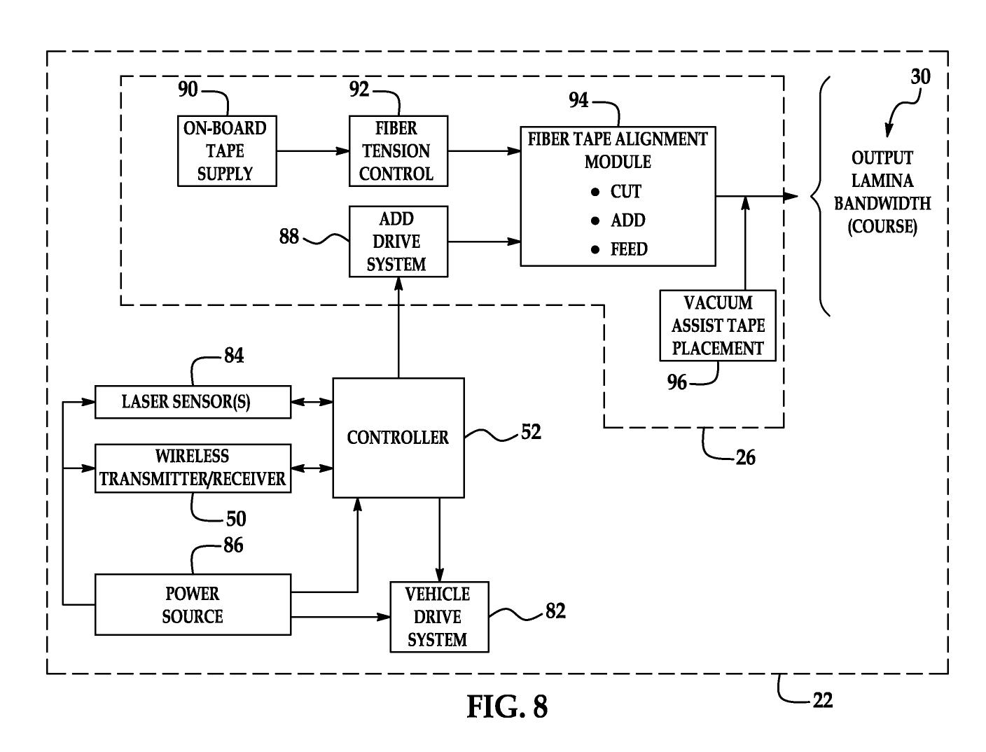

FIG. 8 is an illustration of a functional block diagram of one of the autonomous vehicles.

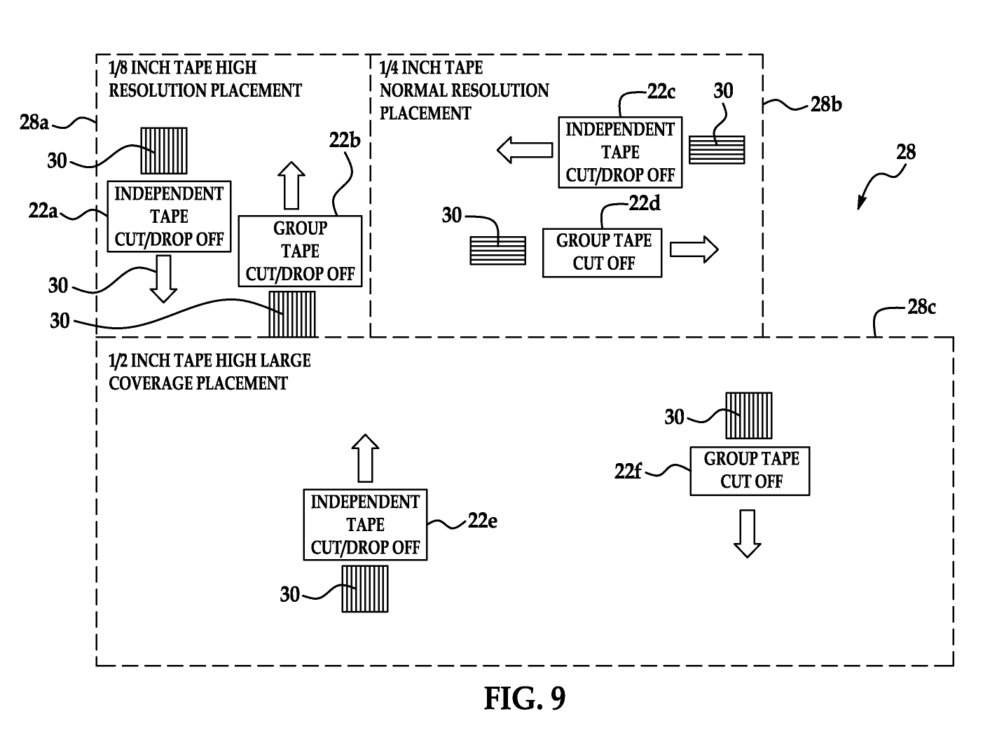

FIG. 9 is an illustration of a diagram showing the use of differently configured autonomous vehicles for laying down differently configured courses of composite tape in different sectors of a tool surface.

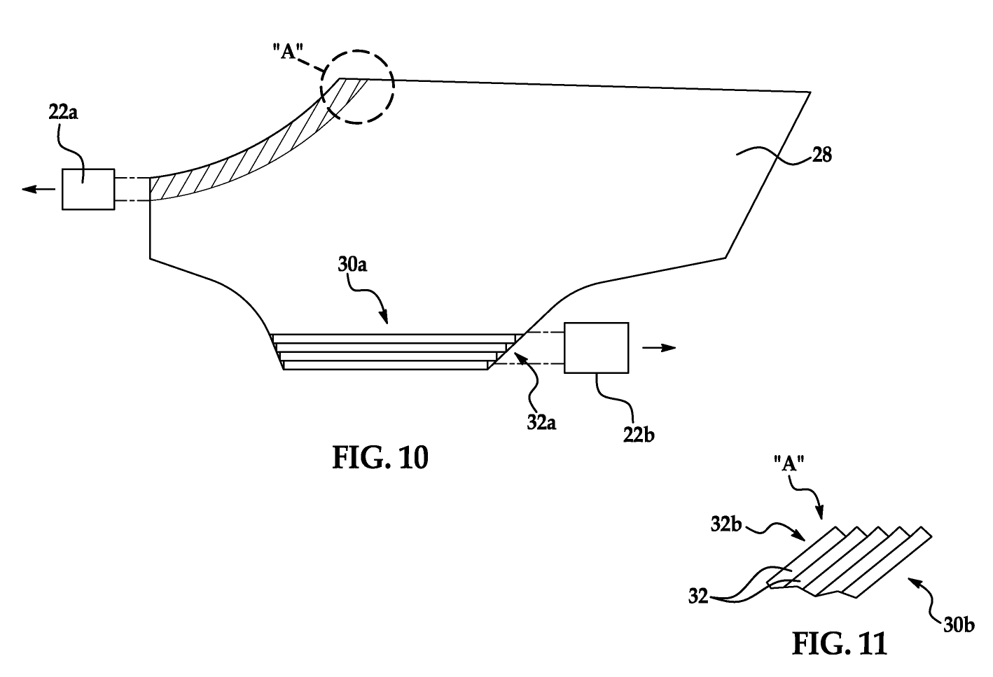

FIG. 10 is a plan view illustration of two autonomous vehicles applying differently configured tape courses.

FIG. 11 is perspective illustration of the area designated as “A” in FIG. 10.

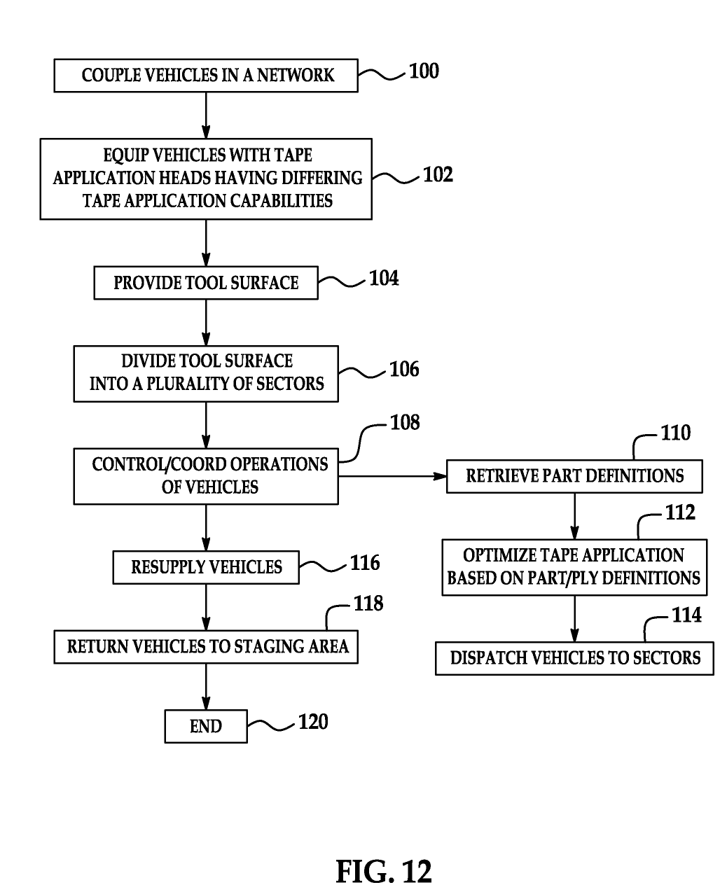

FIG. 12 is an illustration of a flow diagram of a method of laying up a composite laminate using a network of autonomous tape application vehicles.

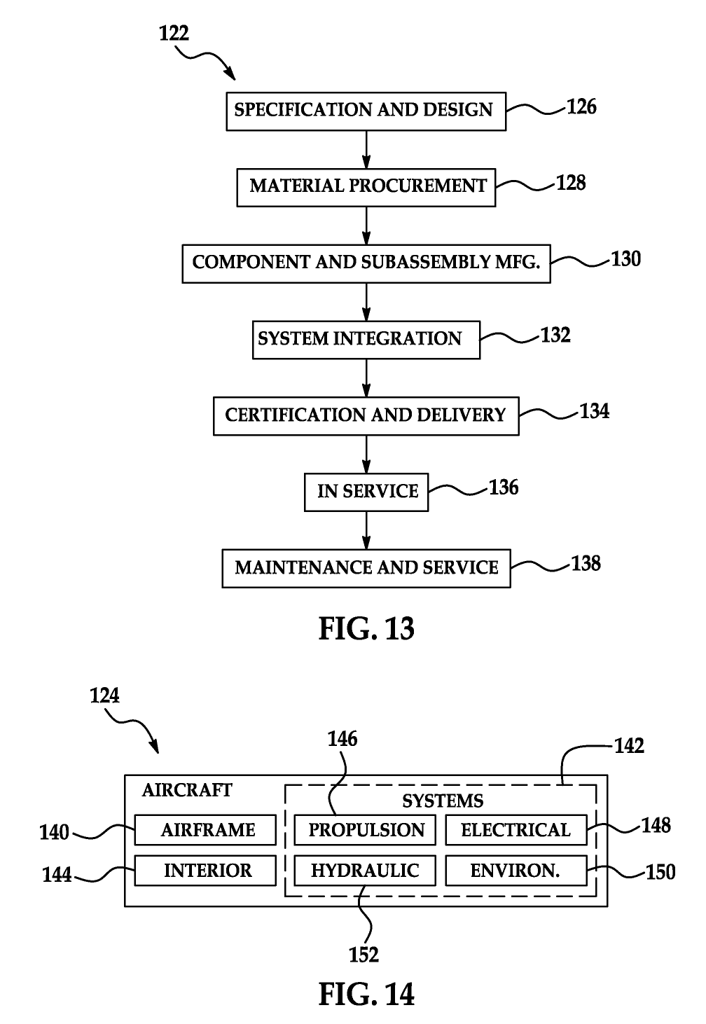

FIG. 13 is an illustration of a flow diagram of aircraft production and service methodology.

FIG. 14 is an illustration of a block diagram of an aircraft.

### DETAILED DESCRIPTION

Referring first to FIGS. 1 and 2, a system 25 is provided for assembling a composite laminate 64 over a tool surface 28. The system 25 includes a plurality of autonomous vehicles 22 coupled in a network 24. Each of the autonomous vehicles 22 may be tailored in its mechanical complexity to perform tasks in a specific sector of the tool surface 28, or to perform a particular lamination task. Each of the vehicles 22 has traction means such as traction wheels 34 which drive the vehicle 22 over the tool surface 28. Each of the vehicles 22 further includes a tape application head 26 which applies multiple strips 32 of composite fiber tape in substantially side-by-side, substantially contiguous relationship which form courses 30a, 30b, and 30c. As will be discussed later in more detail, the tape application heads 26 may be similar in construction to that disclosed in U.S. Pat. No. 4,699,683 in which an array of independent module-based fiber control mechanisms are used to establish a single uniform bandwidth 30a, 30b, 30c.

Each of the tape application heads 26 may be adapted to apply differently configured courses 30a, 30b, and 30c of tape 32 on the tool surface 28. For example, course 30a comprises substantially uniform width tape strips 32 with ply drop-offs 33. Course 30b comprises tape strips 32 which are fewer in number, but wider in width than those forming course 30a. The course 30c applied by tape application head 26c include two strips 32c which are relatively wide and as well as a series of narrow, high resolution strips 32d. The courses 30a-30c shown in FIG. 1 extend substantially parallel to each other, however as will be discussed later, these courses 30a-30c may have orientations that are any of various angles relative to each other.

Referring now to FIG. 3, the network 24 comprises a centrally based wireless transmitter/receiver 36 which is connected to each of the vehicles 22 via a wireless communication link 35. Routing of communication and control signals between the vehicles 22 and the wireless transmitter/receiver 36 is performed by a wireless communications hub 38 which may employ any of various multiplexing techniques.

Additional details of the central control station 27 and one of the vehicles 22 is shown in FIG. 4. The central control station 27 includes a computer 40 which controls communications within the network 25, and is coupled with an operator input/output device 45 that allows an operator to monitor activities of the vehicles 22 and alter routines. The computer 40 may have access to a memory 44 in which there is stored engineering definitions of one or more laminate parts or structures. These engineering definitions define the plies that must be assembled to form the part or structure. The computer 40 may also have access to one or more software programs 42 such as optimization programs, etc. useful in controlling the vehicles 22. Based on part definition retrieved from the memory 44, the computer 40 sends control signals 41 through the communications hub 38 and the wireless transmitter/receiver 36 to the vehicles 22. Additionally, the computer 40 may control a laser guide 46 which projects a laser beam 48 onto the tool surface 28 in order to guide the vehicle 22. The use of a laser beam 48 is merely illustrative of a variety of guidance techniques that may be used to guide the vehicle 22.

Each of the vehicles 22 includes a wireless transmitter/receiver 50 which communicates with the wireless transmitter/receiver 36 at the central station 27 via the wireless communication link 35. In addition to transmitting control signals from the central station 27 to the vehicles 22, the wireless communication link 35 may transmit signals in the vehicles 22 to the central station 27 in order to provide information about the location of the vehicle 22 and the functional status of its internal systems.

One technique for guiding the tape application vehicles 22 is disclosed in U.S. patent application Ser. No. 10/986,292 filed Nov. 12, 2004 and published as US 2006/0106507A1 on May 18, 2006, the entire contents of which is incorporated by reference herein. Each of the vehicles 22 includes a laser sensor 62 and an associated interface control module 60, along with a drive servo motor 58 and a steering servo motor 56, each of which is electronically linked to a controller 52. In addition, the vehicle 22 may include at least one end effector servo motor 54, or actuator, which is electronically operated by the controller 22. In one embodiment, the drive servo motor 58 and the steering servo motor 56 are mechanically coupled to a drive system (not shown) which drives and steers the vehicle 22 through the traction wheels 34 (FIG. 2). The drive system (not shown) may include any suitable device or combination of devices capable of propelling the vehicle 22, such as the drivable and steerable wheels 34, or a drivable track or multiple drivable tracks (not shown) or the like. The drive system (not shown) may be based, for example and without limitation, on a three point surface contact wheels or a tricycle format. The tape laminate, after being formed into a single uniform bandwidth by the fiber control module, may be dispensed between the rear traction drive system. The leading single wheel may be used to steer the vehicle 22 over the tool surface. The steering mechanism (not shown) may include any suitable device or combination of devices capable of changing the vehicle's direction of travel, such as the direction of travel of the wheels 34.

The end effector servo motor 54 may be mechanically coupled to a robotic end effector such as a tape lamination material dispensing head. One example of such a dispensing head is disclosed in U.S. Pat. No. 7,213,629, which is incorporated by reference herein, and which discloses a vacuum assisted ply placement shoe. The laser beam 48 projected from the laser guide 46 delineates a guide path for the vehicle 22 which is detected by the laser sensor 62. The laser sensor 62 generates an electrical signal representative of the location of the laser beam 48 on the tool surface 28. The signal is sent to the interface control module 60 which conditions the signal and sends it to the controller 52. The controller 52 performs an algorithm to determine the location of the laser beam 48 relative to that of the laser sensor 62.

Referring now to FIGS. 5 and 6, a typical composite laminate part 64 is assembled over a tool surface 28 which, in the illustrated embodiment, is divided into a plurality of sectors 28a-28f. Courses 30 of composite tape are applied by the vehicles 22 within the previously described network 25. The vehicles 22 may be associated with particular ones of the sectors 28a-28f which apply courses 30 in these sectors.

Each of the vehicles 22 includes a tape application head that may be particularly configured in terms of its tape application capability to apply a specifically configured course 30 in a particular one or more of the sectors 28a-28f of the tool surface 28. The vehicles 22 may be dispatched from a staging area 66 to a particular one of the sectors 28a-28f. Also, the staging area 66 may be used to carry out maintenance on the vehicles 22, including replenishing the vehicles 22 with composite tape. Since a number of vehicles 22 may be in use simultaneously, no one vehicle 22 is required to carry a significant amount of composite tape, thereby reducing the complexity of the vehicle 22. Moreover, in the event of a malfunction or loss of one vehicle 22, other vehicles 22 in the network 24 may be reassigned to perform the tasks that were assigned to the nonfunctional vehicle.

The path of travel of the vehicles 22 may be controlled by the laser guide 46 which, as previously discussed, directs laser beams 48 onto the tool surface 28 which are sensed by the vehicles 22 and used as a guide to steer the vehicles 22 (FIG. 4). As best seen in FIG. 6, the courses 30 of composite tape applied by the vehicles 22 may be differently configured or oriented with respect to each other as of a result of the vehicles 22 being autonomous and operating independent of each other.

FIG. 7 broadly illustrates the relationship between the central control station 27, the staging area 66 and the tool surface 28. Data representing composite part definitions 72 are used by a tape application optimization algorithm program 74 to optimize the operation of the vehicles 22 so that the vehicles 22 within the network 25 collectively operate at maximum efficiency. The optimization algorithm 74 may optimize vehicle use based on a number of factors, including the capacity of the vehicle, tape width and/or cutter complexity. As previously discussed, the part definitions 72 may be stored in a memory 44 (FIG. 4) and the optimization algorithm program 74 may be one of the programs 42 (FIG. 4) used by the computer 44.

A central task processor 76, which may form a part of the previously discussed computer 40 (FIG. 4) determines the tasks that each of the vehicles 22 should independently carry out, based on the optimization performed by the program 74. The central task processor 76 generates control signals which are routed through a communication hub 38. The communication hub 38 associates the control signals with the corresponding vehicles 22 and effectively routes the control signals to the correct vehicle 22 using the wireless transmitter/receiver 36 and communication link.

The vehicles 22 are dispatched from the staging area 66 to the appropriate sector 28a-28f on the tool surface 28 based on the commands issued by the central control station 27. Additional support functions 70 for the vehicles 22 may include a vehicle motivative support base 78, and a material transfer base 80. The vehicles motivative support base 78 may include a variety of service and maintenance functions, including parts that may be required to support servicing operations of the vehicles 22. Similarly, the material transfer base 80 may comprise a supply system of raw materials used by the vehicles 22, including rolls or cassettes (not shown) of composite fiber tape.

Attention is now directed to FIG. 8 which illustrates the functional modules of one of the vehicles 22. The controller 52 controls both a vehicle drive system 82 and a tape application head 26. The vehicle drive system 82 may include the previously discussed steering servo motor 56 and drive servo motor 58 shown in FIG. 4. The controller 52 steers the vehicle 22 based on guide signals received from one or more laser sensors 84 which sense the position of the laser guide beam 48 (FIG. 5). The controller 52 receives commanded control signals from the central control station 27 (FIG. 7) and may transmit feedback or other signals to the central controller 27 via the wireless transmitter/receiver 50. The wireless transmitter/receiver 50, controller 52, drive system 82 and laser sensors 84 may be powered by a suitable onboard power source 86, which may comprise, for example and without limitation, one or more batteries (not shown).

The tape application head 26 may typically include an onboard supply of tape 90, fiber tension control 92, a fiber alignment module 94, a vacuum assist placement device 96, and an add drive system module 88. The onboard tape supply 90 may comprise a set of composite tape reels or cassettes each of which supplies a strip of tape that is aligned, fed and cut by the fiber alignment module 94. In one embodiment, for example and without limitation, a maximum of six tape reels may be provided which produce an output laminate bandwidth 30 of six, substantially contiguous tape strips. The fiber tension control module 92 may comprise a simple mechanical feedback system (not shown) coupled with a brake (not shown) that provides tension on the supplied tape strips, based on the speed of the vehicle 22.

The fiber alignment module 94 may comprise, for example and without limitation, a module similar to that disclosed in U.S. patent application Ser. No. 12/038,155 filed Feb. 27, 2008. The fiber alignment module 94 disclosed in the above mentioned application may include a wedge and a substantially equally space channel slots that are sized to match the width of the input tape such that a weave pattern is formed and a single bandwidth 30 is output from the tape application head 26. The fiber alignment module 94 includes mechanisms for feeding, cutting and restarting the tape for the module 94.

In some applications, the cutting operation may be performed using a single cutter while in other embodiments, multiple cutters may be used to independently cut each tape strip. The autonomous vehicle 22 reacts against a compaction force applied to the output laminate bandwidth 30 by the tape application head 26 using a technique described in U.S. Pat. No. 7,213,629, which is incorporated by reference herein, in which a vacuum assist tape placement module 96 is employed. The vacuum assist tape placement module 96 produces at least a partial vacuum between the tape and substrate as the tape is being applied which effectively forces and compacts the tape against the substrate. Alternatively, the required tape compaction force may be generated by using a system of manifold directors (not shown) which apply a downward force directly on the vehicle 22, which in turn compacts the tape against the substrate.

FIG. 9 illustrates the flexibility provided by employing a network of autonomous vehicles 22 to simultaneously apply differently configured courses of tape over different sectors of a tool surface 28. Any number of autonomous vehicles 22 may be operational at any one point in time, each completing an independent task which the vehicle 22 is particularly tailored to perform. In the example illustrated in FIG. 9, the tool surface 28 comprises three contiguous sectors 28a, 28b and 28c. In sector 28a a high resolution course 30 of tape is applied which may comprise, for example and without limitation, multiple strips of one eight inch tape applied by one or more autonomous vehicles 22. In this example, autonomous vehicle 22a applies the high resolution courses 30 using multiple, independent cutting mechanisms (not shown) forming part of the module 94 shown in FIG. 8 that allow ply drop-offs and tailoring to be performed. Autonomous vehicle 22a may therefore be employed, for example and without limitation, to apply tape around curved edges or over contoured surfaces. Simultaneous with the operation of autonomous vehicle 22a, a second autonomous vehicle 22b operating within sector 28a may apply courses 30 of tape in which the strips 32 (see FIG. 1) are cut as a group by a single cutting mechanism (not shown) forming part of the module 94 shown in FIG. 8.

Simultaneous with the placement of tape in sector 28a, autonomous vehicles 28c and 28d operating within sector 28b may apply courses 30 of one quarter inch tape representing a normal resolution. Autonomous vehicle 22c may include multiple, independent tape cutting mechanisms (not shown) forming part of the module 94 shown in FIG. 8 that allow ply tailoring and drop-offs, while vehicle 22d may include a single cutting mechanism (not shown) which simultaneously cuts all of the tape strips substantially simultaneously.

Finally, autonomous vehicles 22e and 22f operating in sector 28c may apply courses 30 of one half inch wide tape thereby providing rapid placement of tape over large areas. Vehicles 22e, 22f may have either multiple, independent tape cutting mechanisms or a single, group cutting mechanism.

FIGS. 10 and 11 illustrate a pair of autonomous vehicles 22a, 22b having the tape application heads 26 shown in FIG. 1 and each equipped with a tape cutting mechanism (not shown) of the type previously discussed which allow ply drop-offs that are contoured to curved edges 32a, 32b on the tool 28.

Attention is now directed to FIG. 12 which illustrates the steps of a method for laying up a composite laminate using a network 25 of autonomous vehicles 22. Beginning at 100, the vehicles 22 are coupled within a network 25 of the type shown in FIGS. 3 and 7 in which the operation of the vehicles 22 is controlled at a central command and control center 27. At 102, each of the vehicles 22 is equipped with a tape application head, having one or more tape alignment modules 94 (FIG. 8). As previously described, the vehicles 22 may be equipped with differently configured tape application heads which employ differing types or widths of tape and/or differing functioning capabilities, including, for example and without limitation, the ability to cut an entire bandwidth of tape using a single cutting mechanism, or the ability to cut tapes individually using separate cutting mechanisms.

Next, at 104, a tool surface 28 is provided which may be divided into a plurality of sectors, as shown at 106. At 108, the operation of the vehicles 22 is controlled and coordinated. Step 108 may include retrieving part definitions at 110, which describe the plies, and courses making up each ply required to assemble a particular composite laminate. At 112, the tape application process is optimized based on the retrieved part/ply definitions performed at 110. This optimization process, as previously described, involves optimization of the use of the vehicles 22, including dispatching the vehicles to the various sectors 28a-28f and operating them to simultaneously apply courses of tape in the most time efficient manner. Thus, after the tape application process has been optimized, the vehicles 22 may be dispatched to the various sectors 28a-28f, as shown at step 114.

At 116, as the vehicles 22 exhaust their tape, they may return to the staging area 66 where they are re-supplied with tape. Following completion of the tasks assigned to a vehicle 22, the vehicle 22 returns to the staging area 66, as shown at step 118. When all the vehicles 22 have completed their assigned tasks, the process ends at 120.

Embodiments of the disclosure may find use in a variety of potential applications, particularly in the transportation industry, including for example, aerospace, marine and automotive applications. Thus, referring next to FIGS. 13 and 14, embodiments of the disclosure may be used in the context of an aircraft manufacturing and service method 122 as shown in FIG. 13 and an aircraft 124 as shown in FIG. 14. Aircraft applications of the disclosed embodiments may include, for example, without limitation, composite stiffened members such as fuselage skins, wing skins, control surfaces, hatches, floor panels, door panels, access panels and empennages, to name a few. During pre-production, exemplary method 122 may be used in the specification and design 126 of the aircraft 124 and material procurement 128. For example, the method 122 may be used assess the feasibility of proposed designs, to determine material requirements for a design and/or to produce prototype parts. During production, component and subassembly manufacturing 130 and system integration 132 of the aircraft 124, the disclosed method may be used to produce one or more parts, components or subassemblies. Thereafter, the aircraft 124 may go through certification and delivery 134 in order to be placed in service 136. While in service by a customer, the aircraft 124 may be scheduled for routine maintenance and service 138 (which may also include modification, reconfiguration, refurbishment, and so on).

Each of the processes of method 122 may be performed or carried out by a system integrator, a third party, and/or an operator (e.g., a customer). For the purposes of this description, a system integrator may include without limitation any number of aircraft manufacturers and major-system subcontractors; a third party may include without limitation any number of vendors, subcontractors, and suppliers; and an operator may be an airline, leasing company, military entity, service organization, and so on.

As shown in FIG. 14, the aircraft 124 produced by exemplary method 122 may include an airframe 140 with a plurality of systems 142 and an interior 144. Examples of high-level systems 142 include one or more of a propulsion system 146, an electrical system 148, a hydraulic system 152, and an environmental system 150. The disclosed method may be employed, for example, to fabricate one or more components of the airframe 140. Any number of other systems may be included. Although an aerospace example is shown, the principles of the invention may be applied to other industries, such as the marine and automotive industries.

The apparatus embodied herein may be employed during any one or more of the stages of the production and service method 122. For example, components or subassemblies corresponding to production process 130 may be fabricated or manufactured in a manner similar to components or subassemblies produced while the aircraft 124 is in service. Also, one or more apparatus embodiments may be utilized during the production stages 130 and 132, for example, by substantially expediting assembly of or reducing the cost of an aircraft 124. Similarly, one or more apparatus embodiments may be utilized while the aircraft 124 is in service, for example and without limitation, to maintenance and service 138.

Although the embodiments of this disclosure have been described with respect to certain exemplary embodiments, it is to be understood that the specific embodiments are for purposes of illustration and not limitation, as other variations will occur to those of skill in the art.

What is claimed:

1. A system for fabricating a composite structure, comprising:
a plurality of independently operable vehicles, the vehicles respectively performing differing tape application tasks; and,
a control system for controlling the independent operation of the vehicles.

2. The system of claim 1, wherein:
the vehicles are arranged in a network, and
each of the vehicles includes a tape application head.

3. The system of claim 2, wherein:
the tape application heads are respectively adapted to apply differently configured courses of fiber tape.

4. The system of claim 1, wherein:
at least one of the vehicles includes a tape application head configured to apply strips of fiber tape having differing widths, and
at least one of the vehicles includes a tape application head configured to apply strips of fiber tape having substantially the same width.

5. The system of claim 1, wherein:
at least one of vehicles includes a tape application head configured to apply a course of fiber tape strips having staggered ends, and
at least one of the vehicles includes a tape application head configured to apply strips of fiber tape having differing widths.

6. The system of claim 1, wherein:
at least one of the vehicles includes a tape application head configured to apply multiple strips of fiber tape and to cut the strips as a group, and
at least one of the vehicles includes a tape application head configured to apply multiple strips of fiber tape and to independently cut the strips.

7. The system of claim 1, wherein the control system includes:
ply data defining at least one composite structure,
a software program for optimizing the operation of the vehicles based on the ply data.

8. The system of claim 7, wherein the control system further includes:
a processor for determining tape application tasks to be performed by each of the vehicles and for producing signals for controlling the operation of the vehicles to perform the task, and
a communications hub for routing signals between the vehicles and the processor.

9. A system for fabricating a composite laminate structure, comprising:
a tool surface over which plies of composite tape may be laid;
a plurality of vehicles independently movable over the tool surface and respectively including differently configured composite tape application heads for independently applying differently configured courses of composite tape over the tool surface; and,
control means coupled with the vehicles for controlling the independent movement of the vehicles over the tool surface, and for controlling the operation of the tape application heads.

10. The system of claim 9, wherein:
the tool surface is divided into a plurality of sectors, and
the vehicles are respectively associated with and operate within the sectors.

11. The system of claim 9, wherein the control means includes:
a computer, and
a memory for storing data representing the definitions of composite plies forming the composite structure.

12. The system of claim 11, wherein the control means further includes:
a laminate optimization program used by the computer for optimizing the operation of the vehicles, and
a communications hub for routing signals between the computer and the vehicles.

13. The system of claim 12, wherein the control means includes a wireless communications link between the communications hub and the vehicles.

14. The system of claim 9, further comprising:
a staging area adjacent the tool surface for staging the vehicles.

15. A method of applying at least one course of composite tape over a tool surface, comprising:
coupling a plurality of autonomous vehicles in a network;
equipping each of the vehicles with a composite tape application head for at applying at least one courses of composite tape over the tool surface; and
coordinating the operation of the vehicles within the network, including dispatching the vehicles to apply courses of composite tape in different areas of the tool surface.

16. The method of claim 15, wherein coupling the vehicles in a network includes establishing wireless communication between each of the vehicles and a communications hub.

17. The method of claim 15, wherein coordinating the operation of the vehicles includes retrieving a ply definition of a composite part, and wherein dispatching the vehicles is based on the ply definition.

18. The method of claim 15, wherein coordinating the operation of the vehicles includes using a computer software program to optimize tape application by the vehicles based on the retrieved ply definition.

19. A composite structure produced by the method of applying at least one course of composite tape of claim 15.

20. A method of laying up a composite laminate, comprising:
applying differently configured courses of composite tape over different sectors of a tool surface using a plurality of independently controlled tape application vehicles.

21. The method of claim 20, further comprising:
coupling a plurality of vehicles in a network;
equipping the vehicles with tape application heads having differing tape application capabilities; and,
dispatching the vehicles to the different sectors of the tool surface.

22. The method of claim 20, further comprising:
retrieving a ply definition of the composite laminate; and
using a computer software program to optimize tape application by the tape application vehicles based on the retrieved ply definition.

23. A composite laminate laid up by the method of claim 20.

24. A system for fabricating a composite laminate aircraft part, comprising:
a tool surface over which plies of composite tape may be applied;
a plurality of autonomous vehicles each movable over the tool surface;
a plurality of differently configured tape application heads respectively mounted on the vehicles for applying differently configured courses of composite tape over the tool surface;
a wireless receiver on each of the vehicles;
means for guiding the vehicles over the tool surface;
a wireless transmitter for transmitting control signals to each of the receivers;
a communications hub coupled with the wireless transmitter for routing the control signals to the vehicles;
a processor coupled with the communications hub for assigning tape application tasks to each of the vehicles;
data defining the part and used by the processor to assign the tape application tasks to the vehicles; and
a program used by the processor to optimize the assignment of the tasks.

25. A method of fabricating a composite laminate aircraft part, comprising:
providing a tool surface over which composite tape may be applied;
dividing the tool surface into a plurality of sectors;
providing a plurality of autonomous vehicles;
equipping the vehicles with differently configured tape application heads for applying courses of composite tape in different configurations;
coupling the vehicles in a network;
retrieving a ply definition of the part;
optimizing tape application tasks to be performed by the vehicles based on the retrieved ply definition of the part;
assigning tape application tasks to each of the vehicles;
dispatching the vehicles from a staging area to the sectors based on the task assigned to the vehicles; and,
using the vehicles to independently apply courses of composite tape based on the tasks assigned to the vehicles.
